(19) United States
(12) Patent Application Publication
(10) Pub. No.: US 2016/0261457 A1
(43) Pub. Date: Sep. 8, 2016

(54) RECOVERING FROM CONNECTIVITY FAILURE AT A BRIDGING DEVICE

(71) Applicant: QUALCOMM Incorporated, San Diego, CA (US)

(72) Inventors: Siddharth Gupta, San Diego, CA (US); Rohit Tripathi, San Diego, CA (US); Tyler Byron Wear, San Diego, CA (US); Ady Abraham, Haifa (IL); Elena Salman, Haifa (IL)

(21) Appl. No.: 14/637,038

(22) Filed: Mar. 3, 2015

(51) Int. Cl. H04L 12/24; H04W 76/02; H04W 24/04; H04L 29/12; H04L 12/707

(52) U.S. Cl. CPC H04L 41/0668; H04L 61/2007; H04L 41/0672; H04L 45/22; H04L 61/2015; H04W 24/04; H04W 76/027

(57) ABSTRACT

Homes, enterprise establishments, and other facilities often have routing devices that route traffic to locally connected client devices. A routing device may be connected to an external network (e.g., the internet) through a bridging device, such as an outdoor unit that receives network connectivity through a cellular backhaul connection. If the bridging device's backhaul connection temporarily fails (e.g., due to radio link failure), a public IP address associated with the bridging device and the routing device may change upon recovery of the backhaul connection. If the routing device is not aware of the changed public IP address, subsequent communications between the routing device and the external network may fail. Disclosed are systems and methods for recovering from connectivity failure when using bridging devices to provide network connectivity.

### BACKGROUND

1. Field of the Disclosure

The present application generally relates to network communication and, more specifically, to systems and methods for recovering from a connectivity failure and other events causing Internet Protocol (IP) address reassignment in facilities using a bridging device to an external network.

2. Description of Related Art

Homes, enterprise establishments, and other facilities have traditionally received internet connectivity via wired backhaul connections such as those using public switched telephone networks or dedicated fiber optic lines provided by internet service providers (ISP). Wireless wide area networks (WWAN) may also provide suitable backhaul connections for facilities. A WWAN may be implemented using cellular networks such as Long Term Evolution (4G LTE) networks or other wireless technologies such as the IEEE 802.16 protocol (WiMAX). With the increasing performance and cost efficiency of WWAN technologies, some facilities may now rely primarily or even solely upon WWAN backhaul connections to establish internet connectivity.

A bridging device such as an outdoor unit (ODU) may be deployed to connect a facility with an external network (e.g., WWAN). Specifically, the bridging device may bridge a routing device (e.g., home gateway) within the facility to the external network, where the routing device may manage client devices that are locally connected. The bridging device may, for example, include an LTE transceiver for connecting to an LTE backhaul as well as an Ethernet adapter for directing traffic to and from the routing device. The routing device may provide private Internet Protocol (IP) addresses to the client devices and may further provide network address translation (NAT) to enable the client devices to communicate with and be addressable over the internet through a public IP address associated with the bridging device and routing device.

The bridging device's connection to the external network may experience a connectivity failure such as a radio link failure (RLF). Upon reestablishing connectivity, the bridging device (and the routing device of the facility) may be assigned a new public IP address by the WWAN provider (e.g., a wireless internet service provider (WISP), a telecommunications service provider (TSP), or another communications service provider). The bridging device may also be assigned a new public IP address in other scenarios, such as when the base stations underlying the WWAN trade or hand off clients (e.g., representative of facilities) to and from one another, or when the devices within a facility do not use a dynamically assigned public IP address for an extended period of time, thereby allowing their lease of the public IP address to expire.

### SUMMARY

If a routing device is connected to an external network (e.g., WWAN) through a bridging device (e.g., an outdoor unit), the routing device may not recognize a failure of the connection between the bridging device and the external network or when the public IP address is changed. Instead, the routing device may simply detect a continuous connection to the bridging device regardless of the connectivity failure between the bridging device and the external network. If the bridging device is transparent to the routing device, the routing device may not even be aware that the bridging device is placed between the routing device and the external network, and the routing device may thus assume that it has a steady connection to the external network. Accordingly, the routing device may not recognize connectivity failures or other scenarios that change the public IP address assigned by the external network to the bridging device and the routing device. Subsequent communications between the routing device's client devices and external devices on the external network may fail if the headers on outgoing packets incorrectly reference the previous public IP address instead of the current public IP address.

The bridging device may be in communication with a base station that is part of the external network. As the bridging device is connected to the external network more directly than is the routing device, the bridging device may detect when the external network connection has failed or when the public IP address of the bridging device and the routing device has changed.

The bridging device may indicate connectivity failure and/or connection recovery to the routing device by triggering a restart of the connection between the bridging device and the routing device. For example, the bridging device may restart the connection using a physical layer process such as an auto negotiation restart. A restart of the connection between the bridging device and the routing device may appear to the routing device as though the external network connection has been torn down and reestablished. As a result of the restart, the routing device may determine that a new public IP address has been assigned. The bridging device may additionally or alternatively send a control message to the routing device that prompts the routing device to restart the connection between the bridging device and the routing device.

After the connection between the bridging device and the routing device is restarted, the routing device may send a request message to receive the new public IP address from or through the bridging device. The bridging device may forward this request to a Dynamic Host Configuration Protocol (DHCP) server on the external network, which may provide the new IP address to the routing device through the bridging device. Alternatively, the bridging device may intercept the routing device's request message and provide the new public IP address to the bridging device directly, bypassing the external network and potentially saving time and processing resources.

### BRIEF DESCRIPTION OF THE DRAWINGS

Features, aspects, and embodiments of the disclosure are described in conjunction with the attached drawings, in which:

FIG. 1 shows a schematic diagram illustrating a system for providing network connectivity to a home;

FIG. 2 shows a schematic diagram illustrating an exemplary communication path;

FIG. 3 shows a signal flow diagram illustrating communications between a home gateway, an bridging device, and an external network; and

FIG. 4 shows a flowchart illustrating an example process for handling radio link failure.

These exemplary figures and embodiments are to provide a written, detailed description of the subject matter set forth by any claims that issue from the present application. These exemplary figures and embodiments should not be used to limit the scope of any such claims.

Further, although similar reference numerals may be used to refer to similar structures for convenience, each of the various example embodiments may be considered to be distinct variations. When similar reference numerals are used, a description of the common elements may not be repeated, as the functionality of these elements may be the same or similar between embodiments. In addition, the figures are not to scale unless explicitly indicated otherwise.

### DESCRIPTION OF EMBODIMENT(S)

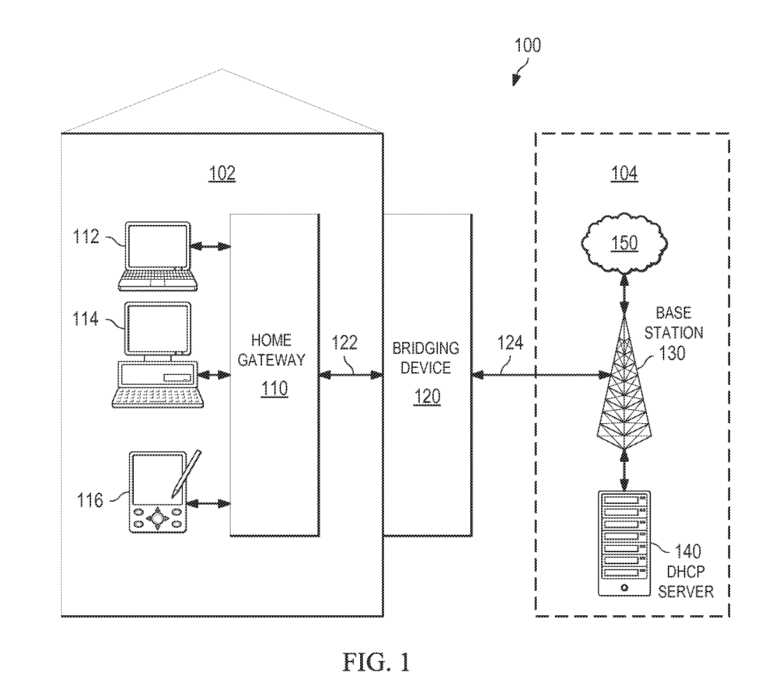

FIG. 1 shows a schematic diagram illustrating a system 100 for providing network connectivity to a home 102. A bridging device 120 (e.g., an outdoor unit) may be provided on or near the home 102 to communicate with an external network 104. The bridging device 120 may, for example, be a transceiver unit that is mounted upon a wall or roof of the home 102 or on a freestanding structure (e.g., a pole) proximate to the home 102. The external network 104 may comprise a wireless wide area network (WWAN) such as a Long Term Evolution (LTE) network or an IEEE 802.16 (WiMAX) network.

The bridging device 120 may communicate with a home gateway 110 over a connection 122, which may be wired (e.g., Ethernet or Ethernet-over-USB) or wireless (e.g., WiFi). The home gateway 110 may in turn communicate with client devices 112, 114, 116 within the home 102. The client devices 112, 114, 116 may comprise desktop computers, laptop computers, servers, tablets, mobile phones, smart appliances, and other networkable devices that may be locally connected to form a local area network (LAN) with the home gateway 110. The home gateway 110 may provide private Internet Protocol (IP) addresses and internet connectivity (e.g., using the bridging device 120) to the client devices 112, 114, 116.

The bridging device 120 may communicate with a base station 130 in the external network 104 through a connection 124. The base station 130 may enable the bridging device 120 to send and receive data, such as IP packets, to and from devices in the Internet 150 as well as infrastructure associated with the base station 130 such as a Dynamic Host Configuration Protocol (DHCP) server 140. The base station 130 and the DHCP server 140 may be provided and operated by a communications service provider (e.g., a wireless internet service provider (WISP) and/or a telecommunications service provider (TSP)). The DHCP server 140 may provide public IP addresses (e.g., IPv4 and/or IPv6 addresses) to various gateways associated with customers of the communications service provider, such as the home gateway 110. The IP addresses may be dynamically assigned, such that the home gateway 110 may become associated with different public IP addresses over time.

When configured as a bridge, the bridging device 120 may forward IP packets to and from the home gateway 110. Accordingly, the bridging device 120 may operate at the data link layer (e.g., layer 2 in the Open Systems Interconnection (OSI) model), and the bridging device 120 may be transparent to the home gateway 110. The home gateway 110 may store the public IP address assigned by the DHCP server 140 and may place the public IP address as source information in the headers of outbound packets (e.g., those to be sent to the Internet 150). The home gateway 110 may further receive and route incoming packets having the public IP address as destination information in their headers to one or more of the client devices 112, 114, 116.

To conserve public IP addresses, the communications service provider managing the DHCP server 140 may establish policies for releasing and reusing public IP addresses. For example, when the base station 130 detects that the connection 124 to the bridging device 120 is lost, the corresponding public IP address may be released at the DHCP server 140, allowing the IP address to be reused for other gateways at other facilities. The DHCP server 140 may provide a new public IP address to the bridging device 120 when the connection 124 between the base station 130 (or a new base station) and the bridging device 120 is reestablished.

The connection 122 between the home gateway 110 and the bridging device 120 may be independent of the connection 124 between the bridging device 120 and the base station 130 in that the connection 122 may remain enabled even when the connection 124 is disabled. If the connection 122 remains unchanged during interruptions of the connection 124, the home gateway 110 may not readily detect when the connection 124 is disabled (e.g., due to radio link failure (RLF) or while the bridging device 120 is being handed-off from base station 130 to another base station 130) or when a new public IP address is given over the connection 124. When the home gateway 110 subsequently attempts to communicate with devices over the Internet 150 using an expired or deallocated public IP address, the communications may fail.

In accordance with the disclosed principles and as described further below, the bridging device 120 may, after receiving a new public IP address from the DHCP server 140, enable the home gateway 110 to also receive the new public IP address. For example, the bridging device 120 may intentionally tear down and reestablishing the connection 122 to the home gateway 110, which may prompt the home gateway 110 to request the new public IP address. Alternatively or additionally, the bridging device 120 may send a control message to the home gateway 110 which instructs the home gateway 110 to restart the connection 122. A physical layer process, such as an autonegotiation restart, may be used to tear down and reestablish the connection 122.

As the bridging device 120 may be more difficult to reset and/or configure than the home gateway 110 due to its location potentially outside of the home 102, the home gateway 110 may be a more convenient option for providing centralized routing for the home 102 in some scenarios. Accordingly, the bridging device 120 may have a bridge mode, where the bridging device 120 forwards packets between the base station 130 and the home gateway 110. By acting in the bridge mode, the bridging device 120 may beneficially avoid providing routing functions such as network address translation (NAT) that may be redundant, and sometimes in conflict, with those of the home gateway 110. For example, two layers of NAT within the home 102 may cause issues with port forwarding at the home gateway 110, as the port information may not pass beyond the bridging device 120. In other scenarios (e.g., those without a home gateway 110), bridging device 120 may operate in a different mode, such as a router mode and may not be referred to as a bridging device.

While a home 102 is shown in FIG. 1, it is to be understood that that the disclosed principles may be applied to any of a wide spectrum of connectivity scenarios and in other types of facilities, such as small offices, enterprise establishments, and public establishments. While the bridging device 120 is shown as an outdoor unit, the bridging device 120 may alternatively be located inside the facilities.

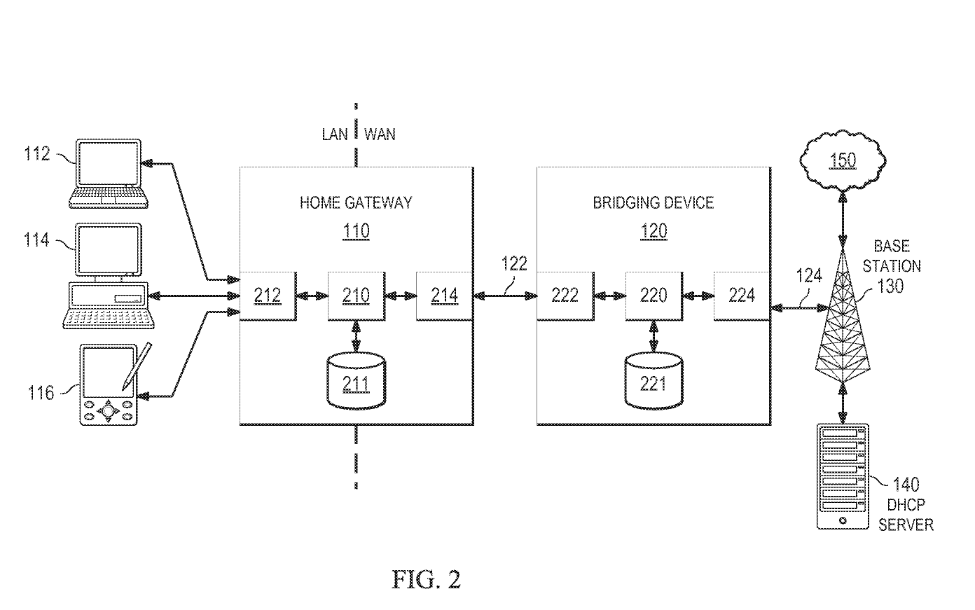

FIG. 2 shows a schematic diagram illustrating an exemplary communication path. A home gateway 110 may comprise a routing engine 210, one or more local area network (LAN) adapters 212, one or more wide area network (WAN) adapters 214, and a memory 211. Communications between the home gateway 110 and the client devices 112, 114, 116 may be considered within a LAN and may occur through the LAN adapter 212. The home gateway 110 may use the LAN adapter 212 to provide private IP addresses to the client devices 112, 114, 116, thereby making the client devices 112, 114, 116 accessible to each other and to other devices in the external network. The routing engine 210 may store these private IP addresses in the memory 211. After the client devices 112, 114, 116 become addressable, they may receive IP packets sent by the home gateway 110 through the LAN adapter 212, thereby gaining network connectivity (e.g., using NAT). Wireless adapters (e.g., wireless local area network (WLAN) adapters) may also be used to connect the home gateway 110 with client devices local to the home gateway 110 (e.g., within or proximate to a home).

The home gateway 110 may use the WAN adapter 214 to communicate with devices and structures external to the LAN (e.g., those provided by the communications service provider). As presented in FIG. 2, the WAN adapter 214 may enable the home gateway 110 to communicate with the bridging device 120. The bridging device 120 may transparently bridge the home gateway 110 to the external network (such as a router in the Internet 150). For example, the home gateway 110 may operate as though it were directly connected to the external network (e.g., Internet 150) without regard to the bridging device 120. The home gateway 110 may receive a public IP address through the WAN adapter 214, which the routing engine 210 may store in the memory 211.

The home gateway's routing engine 210 may enable the home gateway 110 to route IP packets to the client devices 112, 114, 116 connected through the LAN adapter 212. The routing engine 210 may individually select the client devices 112, 114, 116 when routing an IP packet based upon mapping information or rules stored in the memory 211. The memory 211, in addition to storing public and private IP addresses and mapping information, may store instructions which, when executed by the routing engine 210, may allow the home gateway 110 to provide the functionality described herein.

The bridging device 120 may comprise a bridge module 220, a first adapter 222, a second adapter 224, and a memory 221. The first adapter 222 may enable the bridging device 120 to communicate with the home gateway 110. In some embodiments, the first adapter 222 may be an Ethernet adapter connected to the WAN adapter 214 of the home gateway 110, where the WAN adapter 214 may also be an Ethernet adapter, and the connection 122 may be an Ethernet connection. In other embodiments, the home gateway 110 and the bridging device 120 may communicate with one another using an Ethernet-over-USB connection, and, in yet other embodiments, the home gateway 110 and the bridging device 120 may be connected wirelessly.

The second adapter 224 may implement the Radio Resource Control (RRC) protocol to manage a connection 124 between the bridging device 120 and a base station 130 and to determine when the connection 124 fails. The second adapter 224 may also receive public IP addresses from a DHCP server 140 to be associated with and used by the home gateway 110 and/or the bridging device 120.

The bridge module 220 may operate at the data link layer to bridge the home gateway 110 to devices and structures in the WAN. For example, the bridge module 220 may provide a pass-through mechanism between the first adapter 222 and the second adapter 224. In doing so, the bridge module 220 may transfer packets received at the first adapter 222 to the second adapter 224 (and vice versa) without modifying the IP addresses in the packet headers.

The bridge module 220 may, through the second adapter 224, determine when the bridging device 120 has an active connection 124 to the base station 130 (and, more generally, to the internet 150). If the bridge module 220 determines that the connection 124 has recovered from a failure or that the second adapter 224 has otherwise received a new public IP address for the home gateway 110, the bridge module 220 may provide a mechanism by which the home gateway 110 may receive and accept the new public IP address as being associated with the home gateway 110. In some embodiments, the bridge module 220 may, upon receiving a new public IP address from the DHCP server 140, instruct the first adapter 222 to restart (e.g., tear down and reestablish) the connection 122 to the home gateway 110. Alternatively or additionally, the bridge module 220 may send a command message to the home gateway 110 such that its routing engine 210 and/or WAN adapter 214 may restart (e.g., tear down and reestablish) the connection 122. Example techniques for restarting the connection 122 between the home gateway 110 and the bridging device 120 are described in further detail below. When the connection 122 is restarted, the home gateway 110 may request, receive, and accept the new public IP address as its own, storing it in the memory 211.

In some embodiments, the new public IP address may be stored in the bridging device's memory 221 when the bridging device 120 regains its connection 124 to the external network (e.g., through the base station 130). Accordingly, the bridging device 120 may send the new public IP address to the home gateway 110 after the connection 122 is restarted, without additional queries (e.g., DHCP discovery and request messages) being sent to the DHCP server 140. This may beneficially reduce the processing burden upon the DHCP server 140, which may need only to send the new public IP address to the bridging device 120 (e.g., through a DHCP offer message followed by a DHCP acknowledge message) after recovery from radio link failure (RLF) or other events causing the public IP address of the home gateway 110 and bridging device 120 to change. The memory 221 may further have instructions which, when executed by the bridge module 220, may provide the functionality described herein.

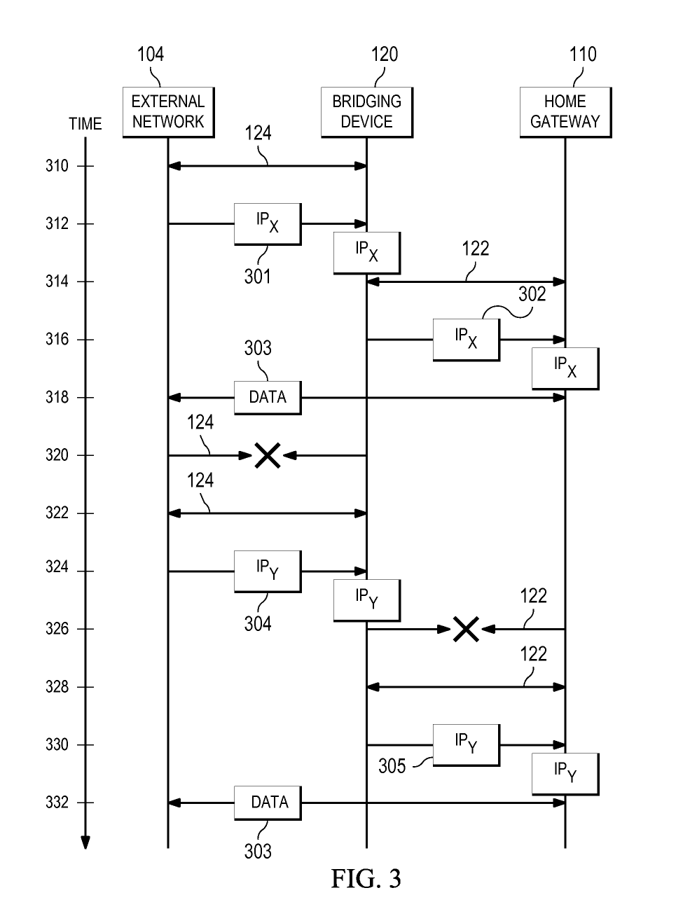

FIG. 3 shows a signal flow diagram illustrating communications between a home gateway 110, a bridging device 120, and an external network 104. The external network 104 may comprise the internet as well as wireless wide area network (WWAN) infrastructure of one or more communications service providers, such as base stations and Dynamic Host Configuration Protocol (DHCP) servers. The DHCP servers may be operable to assign public IP addresses for customers (also referred to as users) of the one or more communications service providers.

At a time 310, a connection 124 may be established between the external network 104 and the bridging device 120. For example, the bridging device 120 or a particular base station in the external network 104 may initiate the connection 124 through the Radio Resource Control (RRC) protocol, which may connect the bridging device 120 with the base station of the external network 104.

At a time 312, the bridging device 120 may receive a message 301 having an IP address, IPX, from the external network 104. For example, a DHCP server may select the IP address IPX from a pool of public IP addresses that are allocated for assignments to users' gateways. The pool of public IP addresses may, for example, be allocated to and managed by a communications service provider.

The bridging device 120 may receive the message 301 having the IP address IPX at substantially the same time 310 that the connection 124 to the external network 104 is established. The bridging device 120 may store the IP address IPX within a memory of the bridging device 120, so that it may, in some embodiments, directly provide this information to the home gateway 110 at a later time.

At a time 314, a connection 122 may be established between the bridging device 120 and the home gateway 110. For example, an Ethernet cable may extend from the bridging device 120 to the home gateway 110. After or while the connection 122 is established, a physical layer process such as autonegotiation may be used to configure the connection 122 between the bridging device 120 and the home gateway 110 to ensure that the physical capabilities of the devices are properly utilized. For example, the autonegotiation process may establish a connection speed and a duplex mode of the connection between the bridging device 120 and the home gateway 110 that are supported by both devices.

The establishment of the connection 122 may indicate to the home gateway 110 that a public IP address is available. Accordingly, the home gateway 110 may send one or more request messages (e.g., DHCP discovery and/or request messages) to the bridging device 120 that request the new public IP address.

At a time 316, the bridging device 120 may send a message 302 having the IP address IPX to the home gateway 110. The message 302 may be prompted or otherwise preceded by the request message(s) sent by the home gateway 110. The bridging device 120 may forward the home gateway's request message(s) to the external network 104, such that a DHCP server may respond. The bridging device 120 may then forward the response from the DHCP server as the message 302 having the IP address IPX to the home gateway 110. In other embodiments, the bridging device 120 may intercept the home gateway's request message(s) and respond to the home gateway 110 directly by sending the message 302 having the IP address IPX to the home gateway 110 without forwarding the request message(s) to the external network 104. While this interception technique may cause the bridging device 120 to deviate slightly from its role as a bridge, the technique may prevent a round trip delay associated with the home gateway's request message(s) traveling to a DHCP server on the external network 104 and the DHCP server's response message traveling to the home gateway 110. Additionally, the technique may decrease the processing load of the DHCP server.

In some embodiments, the home gateway 110 may additionally or alternatively implement stateless address autoconfiguration (SLAAC) to receive the IP address IPX. After receiving the message 302 and storing the IP address IPX, the home gateway 110 and its locally connected client devices may have internet connectivity.

At a time 318, the home gateway 110 may transfer data 303 to and from the external network 104 through the bridging device 120. The data 303 may relate to web content, emails, audio data, video data, Multimedia Broadcast Multicast Services (MBMS), LTE Evolved Multimedia Broadcast Multicast Services (eMBMS), and IP Multimedia Subsystem (IMS) data, among other types of data. For example, when a client device requests to stream video content, the home gateway 110 may send data 303 to the external network 104 through the bridging device 120 requesting the video content. A server on the external network 104 hosting the requested video content may respond by sending data 303 comprising the video content back to the home gateway 110 and the requesting client device through the bridging device 120.

At a time 320, the connection 124 may be lost or severed such that the bridging device 120 becomes disconnected from the external network 104. As a result, the previously assigned IP address IPX may become deallocated, and the home gateway 110 may no longer have a valid IP address. The disconnection may be caused by any of a variety of scenarios. For example, the bridging device 120 and the presently-connected base station of the external network 104 may encounter radio link failure (RLF). Or, the base station may trade or hand off some of its clients (e.g., the bridging device 120 and home gateway 110) to another base station due to loading, link degradation, or other factors. Alternatively, the base station may implement dynamic IP address allocation, and the IP address IPX may simply be released due to a sufficiently long period of non-usage (e.g., as defined by DHCP lease times employed by the related DHCP server).

At a time 322, the bridging device 120 may reestablish its connection 124 with a base station, which may or may not be the same base station previously connected to the bridging device 120.

At a time 324, the bridging device 120 may receive a message 304 having a new IP address, IPY, from the external network 104. This process may be similar to that at the time 312. The bridging device 120 may store the new IP address IPY in a memory, so that it may, in some embodiments, directly provide this information to the home gateway 110.

At a time 326, the bridging device 120 may deliberately disable and restart (or cause to be disabled and restarted) the connection 122 between the bridging device 120 and the home gateway 110. In some embodiments, the bridging device 120 may trigger an autonegotiation restart, which is a physical layer process that restarts the connection 122 to the home gateway 110.

The bridging device 120 may have a software application programing interface (API) that allows the connection 122 to be restarted based upon a trigger condition. In some embodiments, the trigger condition may be the receipt of a new IP address (e.g., IPY) at the bridging device 120, such that the bridging device 120 may disconnect from the home gateway 110 upon receiving a new IP address, whether or not radio link failure (RLF) occurs.

In some embodiments, the bridging device 120 may send a control message to the home gateway 110 to restart the connection 122 between them. The home gateway 110, upon receiving the control message, may disable and restart its connection 122 to the bridging device 120.

Additionally or alternatively, the bridging device 120 may disconnect from the home gateway 110 upon being disconnected from the external network 104 at the time 320, which allows the home gateway 110 to know precisely when internet connectivity is lost. By doing so, the bridging device 120 may remain transparent to the home gateway 110 while conveying information about the state of the connection 124 to the external network.

In some embodiments, restarting the connection 122 does not require either the bridging device 120 or the home gateway 110 to fully restart. Instead, the bridging device 120 and the home gateway 110 may simply restart their respective adapters that are used at either end of the connection 122, thereby decreasing the total time required for the home gateway 110 to receive a new IP address.

At a time 328, the connection 122 may be reestablished between the bridging device 120 and the home gateway 110. Either of the bridging device 120 and the home gateway 110 may wait for a predetermined amount of time (e.g., 1 second) or a random amount of time before attempting to reestablish the connection 122 between them. The reestablishment process may be similar to that at the time 314. Again, the reestablishment of the connection 122 may prompt the home gateway 110 to send request message(s) for the new public IP address.

At a time 330, the bridging device 120 may respond to the home gateway's request message(s) by providing the new IP address IPY in a message 305. For example, the bridging device 120 may provide the home gateway 110 with the message 305 having the new IP address IPY directly (e.g., without forwarding the home gateway's request message(s) to the external network 104), in a manner that may be similar to the process at the time 316. In some embodiments, the bridging device 120 may forward the home gateway's request message(s) to the external network 104, so that a DHCP server on the external network 104 may reply to the home gateway's message(s) by providing the message 305 to the home gateway 110 through the bridging device 120.

At a time 332, the home gateway 110 may once again transfer data 303 to and from the external network 104 through the bridging device 120. This process may be similar to that at the time 318.

The timings shown in FIG. 3 are for exemplary purposes only, and different orders of actions may occur is some embodiments. Further, the relative spacing between the timing indicators is not necessarily indicative of the relative durations of time between actions.

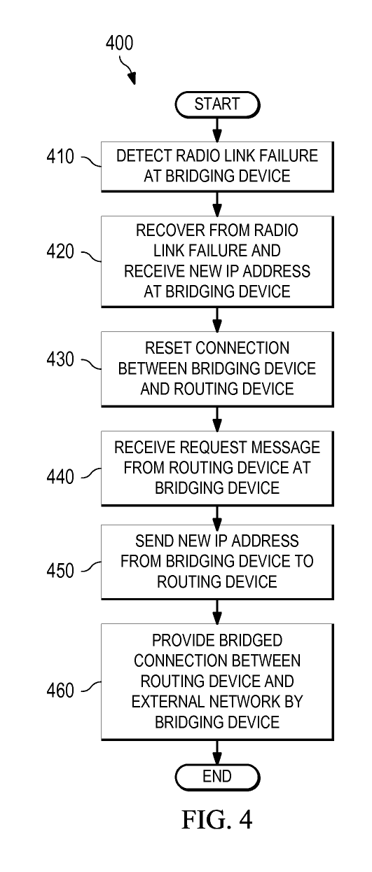

FIG. 4 shows a flowchart illustrating an example process 400 for handling radio link failure (RLF). The process 400 may be performed by a bridging device such as the bridging device 120, as described in FIGS. 1-3. The bridging device may bridge a routing device to an external network, where the routing device may be a home gateway, as described in FIGS. 1-3.

At an action 410, the bridging device may detect radio link failure (RLF) with respect to a connected base station in the external network. This may cause the bridging device and the routing device to temporarily lose internet connectivity. The radio link failure may also cause a public IP address associated with the bridging device and the routing device to be deallocated.

At an action 420, the bridging device may recover from radio link failure by reconnecting with a base station, which may or may not be the same base station to which the bridging device was previously connected. Upon reconnection, the bridging device may receive a public IP address from the external network. The bridging device may locally store this IP address.

At an action 430, the bridging device may restart its connection to the routing device. In some embodiments, the bridging device may initiate an autonegotiation restart process, wherein the connection to the routing device is restarted (e.g., torn down and reestablished) at a physical layer (e.g., layer 1 in the Open Systems Interconnection (OSI) model). In some embodiments, the bridging device may send a command message to the routing device that instructs the routing device to initiate the autonegotiation restart process.

At an action 440, the routing device may send a request message for an IP address from or through the bridging device. This action may be prompted by the connection between the routing device and the bridging device being restarted at the action 430.

At an action 450, the bridging device may send a new IP address to the routing device. In some embodiments, the bridging device may intercept the request message sent from routing device at the action 440, such that the request message does not go to the external network. The bridging device may then respond to the request message by providing the IP address that the bridging device may have stored locally.

In some embodiments, the bridging device may simply forward the routing device's request message to the external network, where a DHCP server may receive the request message and provide a response message having the new IP address to the bridging device. The bridging device may forward this response message to the routing device. In some embodiments, such as those where the routing device is configured to use stateless address autoconfiguration (SLAAC), the response message may provide an IP address that is different from that received by the bridging device upon recovering from radio link failure at the action 420.

At an action 460, the bridging device may provide a bridged connection between the routing device and the external network, wherein the bridging device may continue to operate transparently to the routing device. The routing device and any of the routing device's client devices may be accessible to other devices on the external network through the newly assigned IP address.

While FIG. 4 focuses on recovering from radio link failure, the disclosed principles may be applied in other scenarios where a bridging device (e.g., bridging device 120) receives a new IP address that may be conveyed to a routing device (e.g., a home gateway 110) connected to the bridging device. As described above, these other scenarios may include base stations trading or handing off clients amongst one another and the dynamic reallocation of IP addresses due to lease expiration.

While various embodiments in accordance with the disclosed principles have been described above, it should be understood that they have been presented by way of example only, and are not limiting. Thus, the breadth and scope of the disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It is contemplated that the bridge modules, routing engines, adapters and other elements be provided according to the structures disclosed herein in integrated circuits of any type to which their use commends them, such as ROMs, RAM (random access memory) such as DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as digital signal processors (DSP), graphics system processors (GSP), synchronous vector processors (SVP), and image system processors (ISP) all represent sites of application of the principles and structures disclosed herein.

Memory may store any suitable information. Memory may comprise any collection and arrangement of volatile and/or non-volatile components suitable for storing data. For example, memory may comprise random access memory (RAM) devices, read only memory (ROM) devices, magnetic storage devices, optical storage devices, and/or any other suitable data storage devices. In particular embodiments, memory may represent, in part, computer-readable storage media on which computer instructions and/or logic are encoded. Memory may represent any number of memory components within, local to, and/or accessible by a processor.

Implementation is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

Computer networks described in the present application, including external networks and local area networks may include, but are not limited to, computing grid systems, distributed computing environments, cloud computing environment, etc. Such computer networks include hardware and software infrastructures configured to form a virtual organization comprised of multiple resources which may be in geographically disperse locations.

Various terms used in the present disclosure have special meanings within the present technical field. Whether a particular term should be construed as such a “term of art” depends on the context in which that term is used. “Connected to,” “in communication with,” “associated with,” or other similar terms should generally be construed broadly to include situations both where communications and connections are direct between referenced elements or through one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “immediately,” “equivalent,” “during,” “complete,” “identical,” and the like should be understood to mean “substantially at the time,” “substantially immediately,” “substantially equivalent,” “substantially during,” “substantially complete,” “substantially identical,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the subject matter set forth in any claims that may issue from this disclosure. Specifically and by way of example, although the headings refer to a “Field of the Disclosure,” such claims should not be limited by the language chosen under this heading to describe the so-called technical field. Further, a description of a technology in the “Background” is not to be construed as an admission that technology is prior art to any subject matter in this disclosure. Neither is the “Summary” to be considered as a characterization of the subject matter set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method for recovering from connectivity failure of a bridging device, the bridging device in communication with a routing device via a first connection and with an external network via a second connection, the method comprising:
reestablishing, by the bridging device, the second connection between the bridging device and the external network in response to a failure of the second connection;
receiving, at the bridging device, a new internet protocol (IP) address from the external network in response to reestablishing the second connection;
triggering, by the bridging device, a restart of the first connection between the bridging device and the routing device; and
sending, from the bridging device, the new IP address to the routing device following the restart of the first connection.

2. The method of claim 1, wherein the triggering of the restart comprises restarting, by the bridging device, the first connection.

3. The method of claim 1, wherein the triggering of the restart comprises sending, by the bridging device, a command message to the routing device, the command message instructing the routing device to restart the first connection.

4. The method of claim 1, further comprising:
storing the new IP address in a memory in communication with the bridging device.

5. The method of claim 1, further comprising:
intercepting, by the bridging device, a request message from the routing device; and
providing, by the bridging device, the new IP address to the routing device in response to the request message without sending the request message to the external network.

6. The method of claim 1, further comprising:
receiving, at the bridging device, a request message from the routing device;
forwarding, by the bridging device, the request message from the routing device to the external network; and
forwarding, by the bridging device, a response message having the new IP address from the external network to the routing device.

7. The method of claim 1, wherein the bridging device receives the new IP address from a Dynamic Host Configuration Protocol (DHCP) server on the external network.

8. The method of claim 1, wherein the restart of the first connection is associated with a physical layer process.

9. The method of claim 8,
wherein the first connection is a wired connection, and
wherein the physical layer process is an autonegotiation restart.

10. The method of claim 1,
wherein the bridging device is an outdoor unit for deployment outside of a home, and
wherein the routing device is a home gateway for deployment within the home.

11. The method of claim 1,
wherein the second connection is a wireless connection, and
wherein the failure is a radio link failure associated with the second connection.

12. The method of claim 11, wherein the second connection is reestablished to a different base station than the base station associated with the radio link failure.

13. A bridging device for bridging a routing device to an external network, the bridging device comprising:
a first adapter to communicate with the routing device over a first connection;
a second adapter to communicate with the external network over a second connection, the second adapter configured to reestablish the second connection between the bridging device and the external network in response to a failure of the second connection; and
a bridge module configured to receive a new internet protocol (IP) address from the external network through the second adapter in response to the second adapter reestablishing the second connection,
wherein the bridge module is further configured to trigger a restart of the first connection between the first adapter and the routing device, and
wherein the bridge module is further configured to send the new IP address to the routing device through the first adapter following the restart of the first connection.

14. The bridging device of claim 13, wherein the bridge module is further configured to restart the first connection.

15. The bridging device of claim 13, wherein the bridge module is further configured to send a command message to the routing device through the first adapter, the command message instructing the routing device to restart the first connection.

16. The bridging device of claim 13, further comprising:
a memory to store the new IP address.

17. The bridging device of claim 13, wherein the bridge module is further configured to intercept the request message from the routing device and to provide the new IP address to the routing device in response to the request message without sending the request message to the external network.

18. The bridging device of claim 13, wherein the bridge module is further configured to:
receive a request message from the routing device through the first adapter;
forward the request message from the routing device to the external network through the second adapter; and
forward a response message having the new IP address from the external network to the routing device through the first adapter.

19. The bridging device of claim 13, wherein the bridge module is further configured to receive the new IP address from a Dynamic Host Configuration Protocol (DHCP) server on the external network.

20. The bridging device of claim 13,
wherein the bridging device is an outdoor unit for deployment outside of a home, and
wherein the routing device is a home gateway for deployment within the home.
